(19) United States
(12) Patent Application Publication
(10) Pub. No.: US 2009/0096298 A1
(43) Pub. Date: Apr. 16, 2009

(54) LINEAR-MOTION ACTUATOR

(75) Inventor: Shinichi Utsumi, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/250,195

(22) Filed: Oct. 13, 2008

(30) Foreign Application Priority Data
Oct. 11, 2007 (JP) 2007-265022

(51) Int. Cl. H02K 41/00

(52) U.S. Cl. 310/12

(57) ABSTRACT

A linear-motion actuator includes a fixed side member, a rotor rotatably supported by the fixed side member, and an output shaft disposed on an inner side of the rotor and movable in an axial direction. The linear-motion actuator may further include a rotation-linear motion converting mechanism which is provided with a turning prevention means for restricting rotation of the output shaft and which converts rotation of the rotor into a linear motion in the axial direction of the output shaft. The fixed side member may include a tubular member which accommodates a part of the output shaft and guides the output shaft for movement in the axial direction, and the turning prevention means may include an engagement part formed on the output shaft and a restriction part formed on an inner peripheral face of the tubular member and engaged with the engagement part.

### CROSS REFERENCE TO RELATED APPLICATION

The present invention claims priority under 35 U.S.C. §119 to Japanese Application No. 2007-265022 filed Oct. 11, 2007 the entire contents of which are incorporated herein by reference.

### FIELD OF THE INVENTION

At least an embodiment of the present invention may relate to a linear-motion actuator and, more specifically, at least an embodiment of the present invention may relate to a linear-motion actuator in which rotational movement of a rotor is converted into a linear-motion of an output shaft.

### BACKGROUND OF THE INVENTION

A linear-motion actuator in which rotational movement of a rotor is outputted as a linear-motion of an output shaft is disclosed, for example, in Japanese Patent Laid-Open No. Hei 10-322963. The linear-motion actuator is structured in which a female screw formed on an inner peripheral face of a rotating rotor is threadedly engaged with a male screw formed on an outer peripheral face of an output shaft.

The linear-motion actuator structured as described above commonly requires a turning prevention mechanism part by which an output shaft is prevented from being rotated when a rotor is rotated. Further, in addition to the turning prevention mechanism part, a guide part which guides the output shaft when the output shaft is moved in an advancing and retreating direction is also required. In other words, the turning prevention mechanism part and the guide part are required to provide along the output shaft over a region corresponding to a stroke length of the output shaft. As a result, a dimension in an output shaft direction of the linear-motion actuator becomes larger.

### SUMMARY OF THE INVENTION

In view of the problems described above, at least an embodiment of the present invention may advantageously provide a linear-motion actuator in which increasing of a dimension in the axial direction is capable of being restricted even when a turning prevention mechanism part and a guide part are provided.

Thus, according to at least an embodiment of the present invention, there may be provided a linear-motion actuator including a fixed side member which is provided with a stator, a rotor which is rotatably supported by the fixed side member around an axial line, an output shaft which is disposed on an inner side of the rotor and is movable in an axial direction with respect to the fixed side member, and a rotation-linear motion converting mechanism which is provided with a turning prevention means for restricting rotation of the output shaft and which converts rotation of the rotor into a linear motion in the axial direction of the output shaft. The fixed side member includes a tubular member which accommodates a part of the output shaft and guides the output shaft for moving in the axial direction, and the turning prevention means includes an engagement part which is formed on the output shaft and a restriction part which is formed on an inner peripheral face of the tubular member and is engaged with the engagement part.

In accordance with this embodiment of the present invention, the restriction part, which is engaged with an engagement part formed in the output shaft for restricting rotation of the output shaft, and the tubular member, which guides the output shaft for advancing and retreating operation in the axial direction, are integrally formed as one structural member. Therefore, the size of the linear-motion actuator can be reduced. Especially, since the tubular member is disposed to face the inner peripheral face of the rotor, the size in the axial direction of the linear-motion actuator can be reduced. Further, since the number of part items is reduced, manufacturing cost for the linear-motion actuator can be reduced.

In this case, it is preferable that the restriction part is formed from a tip end side to a base end side of the tubular member in the axial direction, and the restriction part is formed as a cut-out part which is cut from the inner peripheral face to an outer peripheral face of the tubular member. According to this structure, the cut-out part functions as a turning prevention part for the output shaft and the output shaft where the engagement part is provided can be securely guided by the cut-out part. In addition, since heat generated at the time of driving the linear-motion actuator can be radiated effectively, service life time of the linear-motion actuator can be improved.

Further, in accordance with at least an embodiment of the present invention, the restriction part is formed from a tip end side to a base end side of the tubular member in the axial direction, and the restriction part is formed as a groove part which is recessed from the inner peripheral face to an outer peripheral face side of the tubular member. According to this structure, the groove part functions as a turning prevention part for the output shaft and the output shaft where the engagement part is provided can be securely guided by the groove part.

In the cases described above, the engagement part may be formed as an engaging projection which is protruded from an outer peripheral face of the output shaft. According to this structure, movement of the output shaft can be securely restricted in the axial direction by the engaging projection. In addition, the movement of the output shaft is restricted by the engaging projection which is protruded from its outer peripheral face and thus contact area of the outer peripheral face of the output shaft with the inner peripheral face of the tubular member can be made smaller and, as a result, output loss due to frictional resistance between the output shaft and the tubular member can be restrained.

Further, in accordance with at least an embodiment of the present invention, at least a part of the output shaft which is accommodated in the tubular member is formed in a rectangular shape in cross section, and the engagement part is a corner part of an outer peripheral face of the part of the output shaft. According to this structure, movement of the output shaft can be securely restricted in the axial direction by utilizing the simple shape of the output shaft.

Further, in accordance with at least an embodiment of the present invention, the tubular member is disposed on an inner peripheral side of the rotor. Specifically, the rotor includes a permanent magnet and a rotor main body part which is fixed with the permanent magnet on an outer peripheral face of the rotor main body part, and the tubular member is disposed to face an inner peripheral face of the rotor main body part on an inner side of the rotor main body part. According to this structure, the size in the axial direction of the linear-motion actuator is prevented from becoming larger due to providing with the tubular member and thus the size of the linear-motion actuator can be reduced.

In addition, in accordance with at least an embodiment of the present invention, a guide plate is arranged on an end of the fixed side member, and the tubular member is integrally formed to protrude from an end face of the guide plate in the axial direction. According to this structure, for example, in comparison with a case where the tubular member is formed in the fixed side member, fixing strength of the tubular member is increased and thus service life time of the linear-motion actuator can be improved. Specifically, it is preferable that the guide plate is provided on an end face on an opposite-to-output side of the fixed side member.

Further, in accordance with at least an embodiment of the present invention, an output bearing through which the output shaft is passed is provided in the other end of the fixed side member. According to this structure, inclination of the output shaft during driving the linear-motion actuator is prevented by the output bearing.

In addition, in accordance with an embodiment of the present invention, a mounting plate which is provided in the fixed side member is formed with an engaging hole into which a positioning projection formed in the said stator is fitted, and a bearing insertion opening is formed in the mounting plate and the output bearing is inserted into the bearing insertion opening. According to this structure, since mounting accuracy of the mounting plate on the stator is improved, concentricity of the output bearing mounted on the mounting plate with output shaft can be enhanced and thus torque loss can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing a linear-motion actuator in accordance with a first embodiment of the present invention which is in a state where an output shaft is located at a retreated end position.

FIG. 2 is an exploded perspective view showing a linear-motion actuator shown in FIG. 1.

FIG. 3 is a cross-sectional view showing the linear-motion actuator in accordance with the first embodiment of the present invention which is in a state where the output shaft is located at an advanced end position.

FIG. 4 is a perspective outward appearance view showing an output shaft and a guide plate (tubular member) which structure a linear-motion actuator in accordance with a second embodiment of the present invention.

FIG. 5 is a perspective outward appearance view showing an output shaft and a guide plate (tubular member) which structure a linear-motion actuator in accordance with a third embodiment of the present invention.

FIG. 6 is an explanatory cross-sectional view showing a state where rotation of the output shaft in the linear-motion actuator shown in FIG. 5 is restricted by the tubular member.

FIGS. 7(a) and 7(b) are explanatory cross-sectional views showing modified examples of the linear-motion actuator shown in FIG. 5. FIG. 7(a) is a modified example in which cut-out parts are formed in a tubular member as a restriction part and FIG. 7(b) is another modified example in which groove parts are formed in a tubular member as a restriction part.

### DETAILED DESCRIPTION OF THE PREFERRED EMBODIMENTS

Linear-motion actuators in accordance with embodiments of the present invention will be described in detail below with reference to the accompanying drawing.

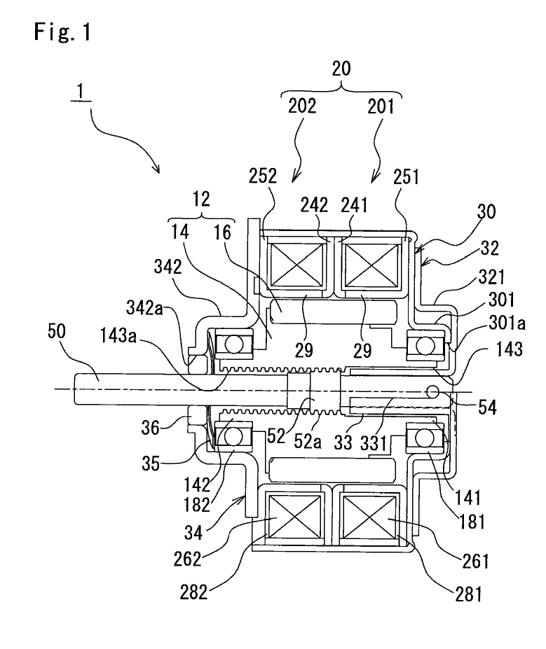

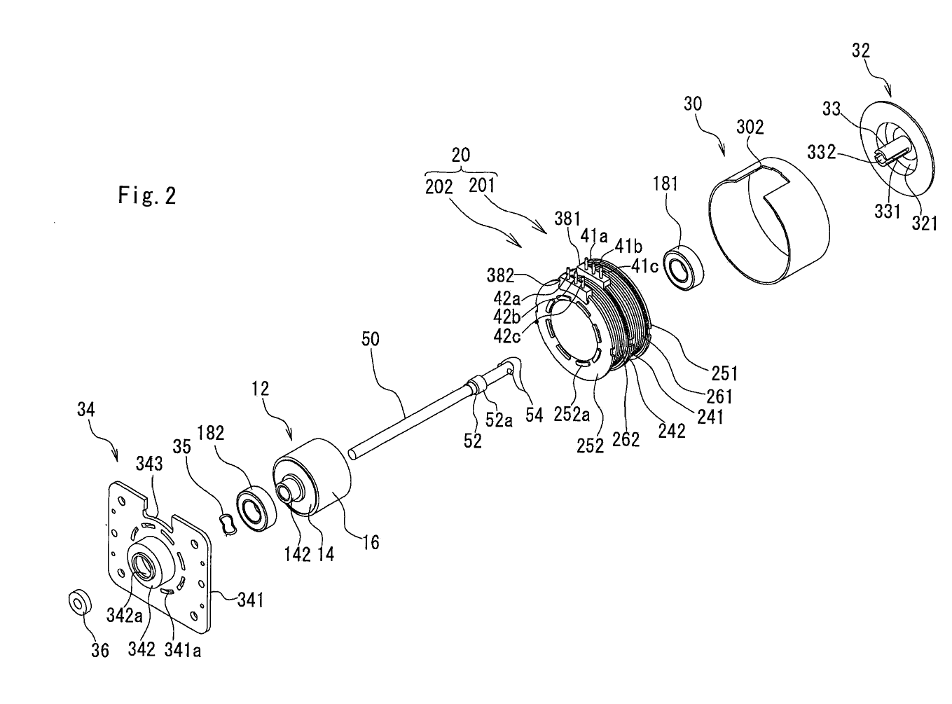

FIG. 1 is a cross-sectional view showing a linear-motion actuator 1 in accordance with a first embodiment of the present invention and FIG. 2 is an exploded perspective view showing the linear-motion actuator 1. The linear-motion actuator 1 is an actuator in which an output shaft 50 performs an advancing-retreating operation in an axial direction with a predetermined amount of stroke. In FIG. 1, the left direction is an advancing direction and the right direction is a retreating direction. In this embodiment, a side in the axial direction where the output shaft 50 is protruded (left direction in FIG. 1) is referred to as an output side, and an opposite side in the axial direction (right direction in FIG. 1) is referred to as an opposite-to-output side.

The linear-motion actuator 1 in accordance with this embodiment includes a fixed side member 30, which is provided with a stator 20, a rotor 12 which is supported to be rotatable around an axial line with respect to the fixed side member 30, and an output shaft 50 which is movable on an inner side of the rotor 12 in an axial direction with respect to the fixed side member 30.

The rotor 12 is structured of a rotor main body part 14 and a permanent magnet 16. Specifically, the rotor main body part 14 is a member made of metal or resin, and cylindrical protruded parts 141 and 142 are formed on both sides of the rotor main body part 14. The protruded part 141 is press-fitted and fixed to a first rotor bearing 181 which is provided on an opposite-to-output side and the protruded part 142 is press-fitted and fixed to a second rotor bearing 182 which is provided on an output side. In this manner, the rotor main body part 14 is rotatably supported by the fixed side member 30 with the axial line as a center. In this embodiment, a well-known ball bearing may be preferably utilized as the first rotor bearing 181 and the second rotor bearing 182.

A through-hole 143 is formed at a center of the rotor main body part 14. A female screw part 143a, which is engaged with a screw member 52 described below, is formed in a roughly half portion on the output side of the through-hole 143. Further, a diameter (size) of the through-hole 143 where the female screw part 143a is not formed (roughly half portion on the opposite-to-output side) is set to be a diameter (size) in which a tubular member 33 described below can be freely inserted.

The permanent magnet 16 is fixed to an outer peripheral face of the rotor main body part 14. For a preferred fixing method for the permanent magnet 16, when the rotor main body part 14 is made of metal, adhesion, for example, may be utilized as a fixing method. Further, when the rotor main body part 14 is made of resin, insert-molding, for example, may be utilized as a fixing method. “N”-poles and “S”-poles are alternately magnetized in a circumferential direction on the permanent magnet 16 which is fixed as described above.

The stator 20 is structured in a two-phase structure so as to face the permanent magnet 16 on an outer peripheral side and is comprised of a first stator assembly 201 and a second stator assembly 202 which are superposed on each other in an axial direction.

The first and the second stator assemblies 201 and 202 respectively include inner stator cores 241 and 242, coil bobbins 281 and 282 around which drive coils 261 and 262 are wound, and outer stator cores 251 and 252 with which the coil bobbins 281 and 282 are sandwiched together with the inner stator cores 241 and 242.

A plurality of pole teeth 29 which is formed in each of the inner stator cores 241 and 242 and the outer stator cores 251 and 252 is disposed so that a plurality of the pole teeth 29 are alternately and adjacently disposed on inner peripheral sides of the coil bobbins 281 and 282. Therefore, in this embodiment, the drive coil 261 formed in a circular ring shape is disposed on the outer peripheries of the respective pole teeth 29 of the inner stator core 241 and the outer stator core 251 of the first stator assembly 201 through the coil bobbin 281. Similarly, the drive coil 262 formed in a circular ring shape is disposed on the outer peripheries of the respective pole teeth 29 of the inner stator core 242 and the outer stator core 252 of the second stator assembly 202 through the coil bobbin 282. An insulating film is formed on the entire surface of the drive coils 261 and 262.

As shown in FIG. 2, a terminal block 381 in which terminal pins 41a through 41c are provided is fixed to an outer periphery of the inner stator core 241. Further, a terminal block 382 in which terminal pins 42a through 42c are provided is fixed to an outer periphery of the outer stator core 252. The terminal pins 41a through 41c and 42a through 42c are made of metal and are fixed to the terminal blocks 381 and 382 by press-fitting or insert-molding. Further, the terminal blocks 381 and 382 are fixed to the outer peripheries of the inner stator core 241 and the outer stator core 252 by insert-molding, press-fitting or the like.

The stator 20 structured as described above is fixed to the fixed side member 30. The fixed side member 30 is a metal member which is formed in a cylindrical shape by press-drawing work. The fixed side member 30 is provided with a function as a case which covers and protects the inner stator cores 241 and 242 and the outer stator cores 251 and 252 that are passages of magnetic flux generated by the stator. A bottomed recessed part 301 which is recessed toward the opposite-to-output side is formed in a bottom face (end face of the opposite-to-output side) of the fixed side member 30 that is abutted with an end face of the stator 20 (outer stator core 251). The first rotor bearing 181 is press-fitted and fixed to the recessed part 301. Further, a hole 301a is formed at a center of the bottom part of the recessed part 301.

A cut-out part 302 is formed in an outer peripheral face of the fixed side member 30. When the stator 20 is fixed to the fixed side member 30, the terminal blocks 381 and 382 are fitted into the cut-out part 302. In this state, the terminal pins 41 a through 41c and 42a through 42c which are mounted on the terminal blocks 381 and 382 are protruded from the outer peripheral face of the fixed side member 30.

A guide plate 32 is fixed to the end face on the opposite-to-output side of the fixed side member 30 by welding or the like. The guide plate 32 is a metal member which is formed in a bottomed cup-shape by press-drawing work. A recessed part 321 is formed at a center portion of the guide plate 32. The recessed part 321 is recessed toward the opposite-to-output side from a portion abutted with the bottom face of the fixed side member 30, which is abutted with the end face of the stator 20 (outer stator core 251). The recessed part 321 of the guide plate 32 is formed larger than the recessed part 301 of the fixed side member 30 and is structured so that the recessed part 301 of the fixed side member 30 is accommodated within the recessed part 321 of the guide plate 32.

A tubular member 33, i.e., a cylindrical member 33 in this embodiment, is formed at the center of the bottom part of the recessed part 321 of the guide plate 32 so as to protrude on the output side and to form a through-hole 332. The cylindrical member 33 serves as a guide member when the output shaft 50 performs an advancing-retreating operation. As shown in FIG. 2, two cut-out parts 331 (corresponding to a restriction part in this embodiment) are formed on the outer peripheral face in the axial direction of the cylindrical member 33. The cut-out part 331 is formed from a tip end on the output side of the cylindrical member 33 to a position just before a base end on the opposite-to-output side of the cylindrical member 33, i.e., just before the bottom part of the recessed part 321 of the guide plate 32. In this embodiment, a length in the axial direction of the cut-out part 331 is determined on the basis of an amount of stroke of the output shaft 50.

An inner diameter of the cylindrical member 33, i.e., the through-hole 332 is set to be a size in which the output shaft 50 is capable of being inserted with a predetermined clearance for being guided by the cylindrical member 33. An outer diameter of the cylindrical member 33 is set to be a size in which the cylindrical member 33 is capable of being inserted into a through-hole 143 formed in the rotor main body part 14 with a predetermined clearance. As shown in FIG. 1, when the guide plate 32 is fixed to the fixed side member 30, the cylindrical member 33 is inserted through the hole 301a which is formed at the center of the bottom part of the recessed part 301 of the fixed side member 30. As a result, the cylindrical member 33 is located on the inner peripheral side of the rotor main body part 14, i.e., within the through-hole 143 of the rotor main body part 14.

As described above, in this embodiment, the tubular, i.e., cylindrical member 33 which serves as a guide part at the time of advancing and retreating movement of the output shaft 50 is not protruded from the rotor main body part 14 but disposed on the inner peripheral side of the rotor main body part 14 and thus a dimension in the axial direction of the linear-motion actuator 1 can be reduced.

A mounting plate 34 is fixed to an end face on the output side of the stator 20 by welding or the like. When the mounting plate 34 is fixed to the stator 20, engaging holes 341a formed in a flange part 341 of the mounting plate 34 are engaged with positioning projections 252a formed in the end face on the output side of the outer stator core 252 and they are positioned to each other. A plurality of the engaging holes 341a is formed with a predetermined interval on the outer peripheral side so as to surround a ring-shaped recessed part 342 which is formed at the center of the mounting plate 34. Similarly, a plurality of the positioning projections 252a is formed with a predetermined interval on the end face of the outer stator core 252. Since the mounting plate 34 is fixed to the stator 20 as described above, positional accuracy between the stator 20 and the mounting plate 34 can be improved. In this embodiment, a cut-out part 343 is formed at an upper end portion of the mounting plate 34. When the mounting plate 34 is mounted on the stator 20, the terminal block 382 is fitted to the cut-out part 343.

A recessed part 342 which is recessed on the output side is formed at the center of the mounting plate 34 and the second rotor bearing 182 is mounted on the recessed part 342. In this embodiment, a diameter of the recessed part 342 is set to be a size so that the second rotor bearing 182 is slidable in the axial direction within the recessed part 342. Further, a spring washer 35 is disposed between the bottom face of the recessed part 342 and the second rotor bearing 182. Therefore, the rotor main body part 14 is urged by the spring washer 35 on the opposite-to-output side through the second rotor bearing 182. Accordingly, the rotor main body part 14 is sandwiched between the first rotor bearing 181 and the second rotor bearing 182 and thus movement in the axial direction of the rotor main body part 14 is restricted.

A bearing mounting hole 342a is formed in the bottom face of the recessed part 342. An output bearing 36, which is an oil retaining bearing for rotatably supporting the output shaft 50, is press-fitted and fixed to the bearing mounting hole 342a.

In this embodiment, as described above, the mounting plate 34 is fixed to the stator 20 with a high degree of mounting positional accuracy by means of that the engaging holes 341 a are engaged with the positioning projections 252a which are formed on the end face on the output side of the outer stator core 252. In other words, according to this embodiment, mounting positional accuracy of the second rotor bearing 182 and the output bearing 36 which are fixed to the mounting plate 34 can be enhanced with respect to the stator 20. Therefore, an inclination of the rotor main body part 14 supported by the second rotor bearing 182 is restrained and an inclination with respect to the axial line of the output shaft 50 supported by the output bearing 36 is restrained.

The output shaft 50 is a metal rod member. A screw member 52 is press-fitted and fixed to an opposite-to-output side of the output shaft 50. A male screw part 52a, which is threadedly engaged with the female screw part 143a formed on the through-hole 143 of the rotor main body part 14, is formed on the outer peripheral face of the screw member 52. The output shaft 50 is coaxially mounted on the rotor main body part 14 through the screw member 52.

An engaging projection 54 (corresponding to an engagement part in the present embodiment), which is protruded from a shaft face of the output shaft 50 in a radial direction, is provided at two opposite positions on the opposite-to-output side with respect to the position where the screw member 52 of the output shaft 50 is mounted. A part of the output shaft 50 is accommodated into the cylindrical member 33 and the output shaft 50 is engaged with the rotor main body part 14 in a state that the engaging projections 54 are engaged with the cut-out parts 331 of the cylindrical member 33. Therefore, in this embodiment, a turning prevention means for restricting rotation of the output shaft 50 is structured of the engaging projections 54 formed on the output shaft 50 and the restriction part comprised of the cut-out parts 331 of the cylindrical member 33 which are engaged with the engaging projections 54.

An operation of the linear-motion actuator 1 structured as described above will be described below.

FIG. 1 shows a state where the output shaft 50 is in the most retreated position, i.e., a state where the output shaft 50 is located at a retreated end position.

When an electric drive power is supplied from a power supply in this state, a magnetic field for rotation is generated from the drive coils 261 and 262. The rotor main body part 14 to which the permanent magnet 16 is fixed is rotated by the magnetic field.

When the rotor main body part 14 is rotated, the output shaft 50 threadedly engaged with the screw member 52 formed on the through-hole 143 is applied with a force in the same rotating direction which is applied to the rotor main body part 14. However, since the engaging projections 54 of the output shaft 50 are engaged with the cut-out parts 331 of the cylindrical member 33, the movement in the rotating direction of the output shaft 50 is restricted. Therefore, when the rotor main body part 14 is rotated, the output shaft 50 threadedly engaged with the rotor main body part 14 through the screw member 52 is operated to advance in the axial direction while the output shaft 50 is guided by the cylindrical member 33, i.e., guided by means of that the engaging projections 54 are engaged with the cut-out parts 331.

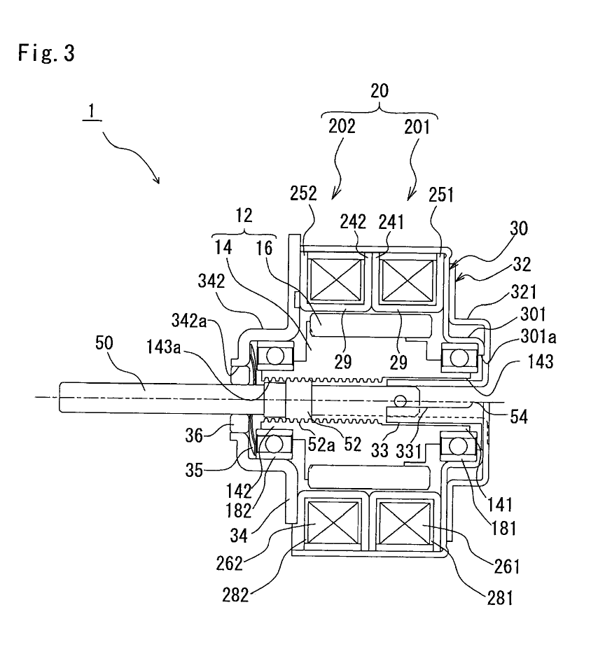

In this manner, the output shaft 50 is advanced with rotation of the rotor main body part 14 and, when the rotor main body part 14 is rotated by a predetermined amount, as shown in FIG. 3, the output shaft 50 is moved to the most advanced state, i.e., to the most advanced end position.

When the rotor main body part 14 is rotated in the opposite direction from the state where the output shaft 50 is located at the advanced end position, similarly to the case when the output shaft 50 is advanced, since movement in the rotating direction of the output shaft 50 is restricted, the output shaft 50 is engaged with the cylindrical member 33, i.e., the engaging projections 54 are engaged with the cut-out parts 331 and thus the output shaft 50 is retreated in the axial direction while the output shaft 50 is guided by the cylindrical member 33. When the rotor main body part 14 is rotated until the engaging projections 54 are abutted with the rear ends of the cut-out parts 331, the output shaft 50 is located at the retreated end position again (see FIG. 1).

As described above, in this embodiment, a rotation-linear motion converting mechanism in which rotary power of the rotor 12 is converted into linear power to be transmitted to the output shaft 50 is provided and thus the output shaft 50 can be advanced and retreated in the axial direction by a predetermined amount of stroke.

In this embodiment, as explained in the operational description, movement in the rotating direction of the output shaft 50 is restricted by the cut-out parts 331 of the cylindrical member 33. Further, the cylindrical member 33 functions to guide the output shaft 50 in the axial direction in the advancing-retreating operation of the output shaft 50. In other words, according to this embodiment, the restriction part for restricting rotation of the output shaft 50 and the guide member for guiding the output shaft in the axial direction are formed integrally in the cylindrical member 33. Therefore, in comparison with a case that the restriction part and the guide member are structured separately, the size of a linear-motion actuator (especially, the size in the axial direction) can be considerably reduced.

The cut-out part 331 formed in the cylindrical member 33 functions as the restriction part for restricting the rotation of the output shaft 50 and, in addition, provides the following operation.

The cylindrical member 33 is provided with a high degree of heat radiation property because contact area with outer air is increased by the cut-out parts 331. In other words, when the linear-motion actuator is driven, heat generated by friction between the cut-out parts 331 and the engaging projections 54 and heat generated by energization to the drive coils 261 and 262 can be efficiently radiated to the outside. As a result, occurrence of malfunction, for example, heat deformation in structural components such as the cylindrical member 33 and the output shaft 50 can be suppressed and service life time of the linear-motion actuator 1 can be improved.

Further, the cylindrical member 33 is formed with the cut-out part 331 and the through-hole 332 connected to the outside, which act as an escape route for air (air escape part). In other words, in a case that the cut-out part 331 and the through-hole 332 are not formed, when the output shaft 50 is retreated, a repulsive force of air which is compressed in the cylindrical member 33 and expanded due to being heated is applied to the output shaft 50. However, in this embodiment, the air is escaped through the through-hole 332 and the cut-out part 331 formed in the cylindrical member 33 to the outside of the linear-motion actuator 1 and thus the advancing-retreating operation of the output shaft 50 can be efficiently performed.

In addition, the output shaft 50 is advanced and retreated on the inner peripheral side of the cylindrical member 33 in a state that the outer peripheral face of the output shaft 50 is provided with a predetermined clearance to the inner peripheral face of the through-hole 332 of the cylindrical member 33. In other words, in this embodiment, the entire circumference of the outer peripheral face of the output shaft 50 is arranged so as not to contact with the inner peripheral face of the cylindrical member 33. Therefore, frictional resistance of the outer peripheral face of the output shaft 50 with the inner peripheral face of the cylindrical member 33 in the advancing-retreating operation of the output shaft 50 hardly occurs. In other words, In this embodiment, although friction of the engaging projection 54 formed in the output shaft 50 with the cut-out part 331 formed in the cylindrical member 33 acts as resistance for the advancing-retreating operation of the output shaft 50, frictional resistance between the outer peripheral face of the output shaft 50 and the inner peripheral face of the cylindrical member 33 hardly exists and thus torque loss of the rotor 12 in the advancing-retreating operation of the output shaft can be reduced considerably.

The output shaft 50 performing the advancing-retreating operation as described above is supported by means of that the engaging projections 54 are engaged with the cut-out parts 331 in the end portion on the opposite-to-output side. Further, the output shaft 50 is supported by the rotor main body part 14 through the screw member 52 on an output side of the position where the engaging projections 54 are formed. In addition, the output shaft 50 is also supported by the output bearing 36 on the output side. In other words, the output shaft 50 is supported at three positions between the output side and the opposite-to-output side of the fixed side member 30 and thus the advancing-retreating operation is not performed in the state where the output shaft 40 is inclined with respect to the axial line of the linear-motion actuator 1. Therefore, the output shaft 50 can be efficiently advanced and retreated.

In this embodiment, the cylindrical member 33 may be formed in the fixed side member 30 instead of forming in the guide plate 32. However, when the cylindrical member 33 is formed in the guide plate 32 which is a separate member from the fixed side member 30 like the embodiment described above, fixing strength of the cylindrical member 33 is increased and thus service life time of the linear-motion actuator is improved. Further, since the cylindrical member 33 can be formed by press-drawing work in a sheet of metal plate, dispersion of dimensional accuracy of the cylindrical member 33 and the like is reduced.

In addition, in a case that the cylindrical member 33 is formed in the fixed side member 30, the cylindrical member 33 becomes an obstacle in order to perform press fitting work of the first rotor bearing 181 to the recessed part 301. However, in this embodiment, since the cylindrical member 33 is formed in the guide plate 32 which is a separate member, efficiency of press fitting work of the first rotor bearing 181 can be improved.

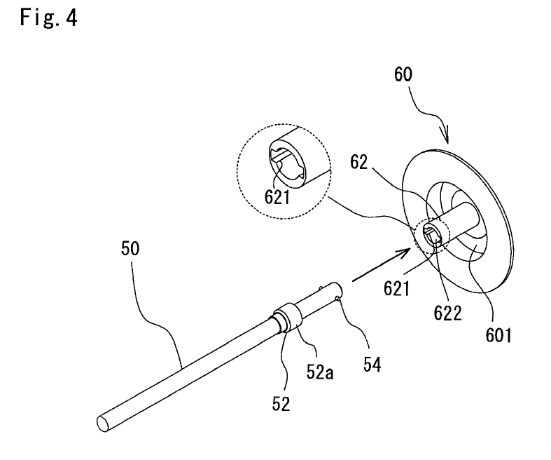

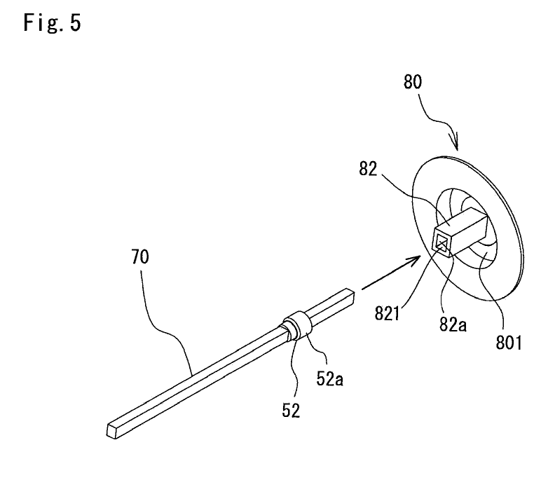

Next, linear-motion actuators 1 in accordance with a second and a third embodiments of the present invention will be described below. The linear-motion actuator 1 is, similarly to the first embodiment, an actuator in which an output shaft 50 performs an advancing-retreating operation by a predetermined amount of stroke. However, only a structure for restricting rotation of the output shaft 50 is different from the first embodiment. Therefore, the structure different from the first embodiment will be mainly described below. In these embodiments, in FIGS. 4 and 5, the same notational symbols are used in the same structural components as the first embodiment.

FIG. 4 is a perspective outward appearance view showing an output shaft 50 and a guide plate 60 (tubular, i.e., cylindrical member 62) which structure a linear-motion actuator 1 in accordance with a second embodiment of the present invention.

Similarly to the first embodiment, the output shaft 50 is fixed with a screw member 52, on which a male screw part 52a threadedly engaging with a female screw part 143a of a rotor main body part 14 is formed, and is fixed with engaging projections 54 protruding in a radial direction from its shaft face.

The guide plate 60 is formed with a cylindrical member 62 which is formed at a center portion in a recessed part 601 and whose shape is different from the first embodiment. The cylindrical member 62 is formed so as to protrude on the output side and its center hole is penetrated through the cylindrical member 62 so as to form a through-hole 622. Specifically, groove parts 621 (corresponding to the restriction part in an embodiment of the present invention) are formed on an inner peripheral face of the through-hole 622 of the cylindrical member 62. The groove part 621 is provided with a depth which does not reach to an outer peripheral face of the cylindrical member 62, in other words, formed in a different shape from the cut-out part described in the first embodiment. The groove part 621 is formed from a tip end (output side) of the cylindrical member 62 and formed to just before a base end (opposite-to-output side) of the cylindrical member 62 Oust before the recessed part 601 of the guide plate 60). In this embodiment, a length in the axial direction of the groove part 621 is determined on the basis of an amount of stroke of the output shaft 50.

In the linear-motion actuator 1, the output shaft 50 is mounted on the rotor main body part 14 in a state that the engaging projections 54 are engaged with the groove parts 621. According to this structure, movement in the rotating direction of the output shaft 50 is restricted. In other words, when the rotor main body part 14 is driven to rotate, a force in the rotating direction is applied to the output shaft 50 which is threadedly engaged with the rotor main body part 14. However, since rotational operation of the output shaft 50 is restricted by the groove parts 621, the output shaft 50 is advanced and retreated in the axial direction. Therefore, in this embodiment, a turning prevention means for restricting rotation of the output shaft 50 is structured of the engaging projections 54 formed on the output shaft 50 and the restriction part comprised of the groove parts 621 of the cylindrical member 62 which are engaged with the engaging projections 54.

As described above, in the second embodiment, a rotation-linear motion converting mechanism is provided in which movement in the rotating direction of the output shaft 50 is restricted by the groove parts 621 and thus the movement of the output shaft 50 can be surely limited in the axial direction. Further, in comparison with a case where the cut-out part is formed as the restriction part for restricting rotation of the output shaft 50, forming of the cylindrical member 62 is easy and thus manufacturing cost for the linear-motion actuator 1 can be reduced.

FIG. 5 is a perspective outward appearance view showing an output shaft 70 and a guide plate 80 (tubular and rectangular member 82) which structure a linear-motion actuator 1 in accordance with a third embodiment of the present invention.

The output shaft 70 is formed in a rectangular shape in its cross section and is fixed with a screw member 52 on which a male screw part 52a is formed and is threadedly engaged with a female screw part 143a of the rotor main body part 14. The output shaft 70 is, different from the first and the second embodiments, not provided with the engaging projections 54 protruding in the radial direction.

The guide plate 80 is formed with a recessed part 801 at its center portion so that an inner peripheral face 82a of the tubular and rectangular member 82 which is formed in the recessed part 801 is formed in a rectangular shape in its cross section. The tubular member 82 is formed so as to protrude on the output side and its center through-hole 821 is penetrated through the tubular member 82. A size in cross section of the inner peripheral face 82a of the through-hole 821 is formed slightly larger than that in cross section of the output shaft 70.

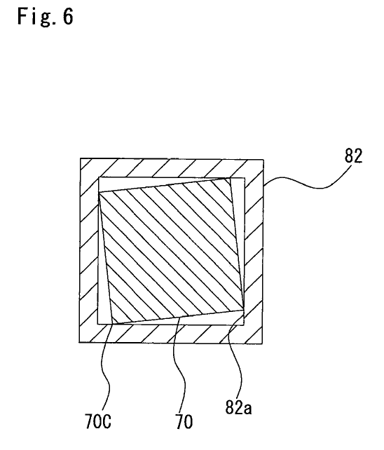

In the linear-motion actuator 1, the output shaft 70 is mounted on the rotor main body part 14 in a state where a part of the output shaft 70 is inserted into the tubular and rectangular member 82. In this manner, movement in the rotating direction of the output shaft 70 is restricted. Specifically, when the rotor main body part 14 is rotationally driven, a force in the rotating direction is applied to the output shaft 70 which is threadedly engaged with the rotor main body part 14. However, as shown in FIG. 6 (cross-sectional view in a state where the rectangular output shaft 70 is inserted into the tubular and rectangular member 82), corner parts 70C of the output shaft 70 (corresponding to the engagement part in an embodiment of the present invention) are abutted with an inner peripheral face 82a of the tubular and rectangular member 82 (corresponding to the restriction part in an embodiment of the present invention) and thus rotational operation of the output shaft 70 is restricted. Therefore, the output shaft 70 performs an advancing-retreating operation in the axial direction in a state shown in FIG. 6. In other words, in the third embodiment, a turning prevention means for restricting rotation of the output shaft 70 is structured of the engagement part comprised of four corner parts 70C of the rectangular output shaft 70 and the restriction part comprised of four inner peripheral faces 82a of the tubular member 82 which are to be engaged with the corner parts 70C.

As described above, in the third embodiment, the rotation-linear motion converting mechanism is provided in which movement in the rotating direction of the output shaft 70 is restricted by means of that the cross section of the output shaft 70 is formed in the rectangular shape and the inner peripheral face 82a of the tubular member 82 is formed in the rectangular shape. Therefore, movement of the output shaft 70 can be limited to the axial direction securely.

In the third embodiment, movement in the rotating direction of the output shaft 70 is restricted by means of that the cross sections of the output shaft 70 and the inner peripheral face 82a of the tubular member 82 are formed in the rectangular shape. However, the cross-sectional shape in the present invention is not limited to the rectangular shape. For example, other polygonal shapes may be effectively utilized.

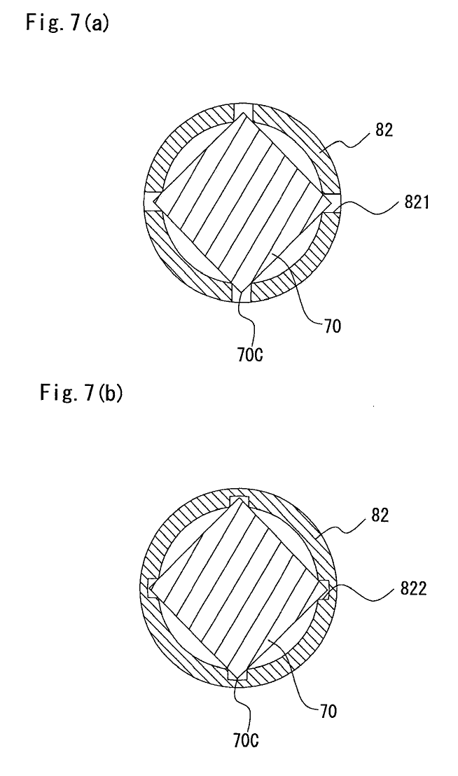

Modified examples of the shape of the tubular member 82 are shown as follows. For example, as shown in a cross-sectional view of FIG. 7(a), a turning prevention means may be structured in which cut-out parts 821 are formed as a restriction part in the tubular member 82 and corner parts 70C of the output shaft 70 are engaged with the cut-out parts 821 to restrict movement in a rotating direction of the output shaft 70.

Further, as shown in a cross-sectional view of FIG. 7(b), another turning prevention means may be structured in which groove parts 822 are formed as a restriction part in the tubular member 82 and the corner parts 70C of the output shaft 70 are engaged with the groove parts 822 to restrict movement in the rotating direction of the output shaft 70.

As described above, in accordance with the linear-motion actuators 1 in the embodiments. the restriction part (cut-out part 821 or groove parts 621, 822) which is engaged with the engagement part (engaging projection 54 or corner part 70c) formed in the output shaft 50 (70) to restrict rotation of the output shaft and the tubular member 33 (62, 82) for guiding the output shaft 50 (70) at the time of advancing and retreating in the axial direction are integrally formed with each other. Therefore, the size in the axial direction of the linear-motion actuator can be reduced. Further, since the number of part items is reduced, manufacturing cost for the linear-motion actuator can be reduced.

Further, movement in the rotating direction of the output shaft 50 (70) is restricted by the engagement part (engaging projection 54 or corner part 70c). Therefore, abutting area of the output shaft 50 (70) with the tubular member 33 (62, 82) is reduced and output loss due to frictional resistance between the output shaft 50 (70) and the tubular member 33 (62, 82) can be restrained.

Further, according to the linear-motion actuator 1 in accordance with the first and the second embodiments, movement in the rotating direction of the output shaft 50 can be restricted securely by using the cut-out part 331 or the groove part 621 which is formed in the tubular member 33 or 62.

In addition, according to the linear-motion actuator 1 in accordance with the third embodiment, movement in the rotating direction of the output shaft 70 is restricted by the corner part 70C which is formed on the outer peripheral face of the output shaft 70. Therefore, the shape of the output shaft 70 can be made simple.

Further, in the linear-motion actuator 1 in accordance with the embodiments, the tubular member 33 (62, 82) is disposed on the inner peripheral side of the rotor main body part 14. Therefore, the size in the axial direction of the linear-motion actuator 1 does not become larger due to the tubular member 33 (62, 82) and thus the size of the linear-motion actuator 1 can be reduced.

In addition, the tubular member 33 (62, 82) is integrally formed from an end face of the guide plate 32 (60, 80) in the axial direction. Therefore, for example, in comparison with a case where the tubular member 33 (62, 82) is formed in the fixed side member 30, fixing strength of the tubular member 33 (62, 82) is increased and thus service lifetime of the linear-motion actuator 1 can be improved.

Further, the output bearing 36 through which the output shaft 50 (70) is passed is provided at the other end of the fixed side member 30. Therefore, inclination of the output shaft 50 (70) during driving the linear-motion actuator is prevented.

In addition, the mounting plate 34 in which the engaging holes 341a fitted into the positioning projections 252a formed in the outer stator core 252 are formed is provided in the fixed side member 30. Therefore, mounting accuracy of the mounting plate 34 on the stator 20 is improved. Further, the bearing insertion opening 342a into which the output bearing 36 is inserted is formed in the mounting plate 34. Accordingly, mounting accuracy of the output bearing 36 which is mounted on the mounting plate 34 is also improved and thus concentricity of the output bearing 36 with the output shaft 50 (70) can be enhanced and, as a result, torque loss can be reduced.

Although the present invention has been shown and described with reference to specific embodiments, various changes and modifications will be apparent to those skilled in the art from the teachings herein.

For example, in the embodiment described above, the screw member 52 which is threadedly engaged with the rotor main body part 14 is mounted on the output shaft 50 (70) to convert a rotary power of the rotor 12 into an advancing-retreating operation of the output shaft 50 (70). However, it may be structured that male screw working is applied to an outer peripheral face of the output shaft 50 (70) instead of using the screw member 52 and the output shaft 50 (70) is threadedly engaged with the rotor main body part 14.

Further, in the embodiment described above, the guide plate 32 (60, 80), i.e., the tubular member 33 (62, 82) is arranged on the opposite-to-output side. However, it may be structured that the guide plate 32 (60, 80) is arranged on the output side and the mounting plate 34 (output bearing 36) is arranged on the opposite-to-output side.

A widely known control method for a stepping motor is preferable to control rotation of the rotor 12 but another control method, for example, for a DC motor may be utilized.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A linear-motion actuator comprising:
a fixed side member which is provided with a stator;
a rotor which is rotatably supported by the fixed side member around an axial line;
an output shaft which is disposed on an inner side of the rotor and is movable in an axial direction with respect to the fixed side member; and
a rotation-linear motion converting mechanism which is provided with a turning prevention means for restricting rotation of the output shaft and which converts rotation of the rotor into a linear motion in the axial direction of the output shaft;
wherein the fixed side member comprises a tubular member which accommodates a part of the output shaft and guides the output shaft for movement in the axial direction, and
wherein the turning prevention means comprises an engagement part which is formed on the output shaft and a restriction part which is formed on an inner peripheral face of the tubular member and which is engaged with the engagement part.

2. The linear-motion actuator according to claim 1, wherein
the restriction part is formed from a tip end side to a base end side of the tubular member in the axial direction, and
the restriction part is formed as a cut-out part which is cut from the inner peripheral face to an outer peripheral face of the tubular member.

3. The linear-motion actuator according to claim 1, wherein
the restriction part is formed from a tip end side to a base end side of the tubular member in the axial direction, and
the restriction part is formed as a groove part which is recessed from the inner peripheral face to an outer peripheral face side of the tubular member.

4. The linear-motion actuator according to claim 1, wherein the engagement part is an engaging projection which is protruded from an outer peripheral face of the output shaft.

5. The linear-motion actuator according to claim 1, wherein
at least a part of the output shaft which is accommodated in the tubular member is formed in a rectangular shape in cross section, and
the engagement part is a corner part of an outer peripheral face of the part of the output shaft.

6. The linear-motion actuator according to claim 1, wherein
a guide plate is arranged on an end of the fixed side member, and
the tubular member is integrally formed to protrude from an end face of the guide plate in the axial direction.

7. The linear-motion actuator according to claim 6, further comprising an output bearing through which the output shaft is passed and which is provided in an other end of the fixed side member.

8. The linear-motion actuator according to claim 7, further comprising
a mounting plate which is provided in the fixed side member and which is formed with an engaging hole into which a positioning projection formed in the stator is fitted, and
a bearing insertion opening which is formed in the mounting plate and into which the output bearing is inserted.

9. The linear-motion actuator according to claim 1, wherein the tubular member is disposed to face an inner peripheral side of the rotor.

10. The linear-motion actuator according to claim 9, wherein
the rotor includes a permanent magnet and a rotor main body part which is fixed with the permanent magnet on an outer peripheral face of the rotor main body part,
the tubular member is disposed to face an inner peripheral face of the rotor main body part on an inner side of the rotor main body part, and
the restriction part is one of a cut-out part and a groove part which is formed from a tip end side to a base end side of the tubular member that is inserted into the inner side of the rotor main body part.

11. The linear-motion actuator according to claim 10, wherein the engagement part is an engaging projection which is formed to protrude from an outer peripheral face of the output shaft to engage with one of the cut-out part and the groove part formed in the tubular member.

12. The linear-motion actuator according to claim 9, wherein
the rotor includes a permanent magnet and a rotor main body part which is fixed with the permanent magnet on an outer peripheral face of the rotor main body part,
the tubular member is disposed to face an inner peripheral face of the rotor main body part on an inner side of the rotor main body part,
at least a part of the output shaft which is accommodated in the tubular member that is inserted into an inner side of the rotor main body part is formed in a rectangular shape in cross section, and
the engagement part which is formed in the output shaft is a corner part on an outer peripheral face formed in the rectangular shape in cross section of the output shaft.

13. The linear-motion actuator according to claim 9, further comprising a guide plate which is provided on an end face on an opposite-to-output side of the fixed side member,
wherein the tubular member is formed to protrude from an end face of the guide plate to face the inner peripheral face of the rotor.

14. The linear-motion actuator according to claim 13, further comprising an output bearing for passing through the output shaft which is provided in an output end face of the fixed side member.

15. The linear-motion actuator according to claim 14, further comprising
a mounting plate which is provided in the fixed side member and which is formed with an engaging hole into which a positioning projection formed in the said stator is fitted, and
a bearing insertion opening which is formed in the mounting plate and into which the output bearing is inserted.
